(19) United States
(12) Patent Application Publication
(10) Pub. No.: US 2012/0306217 A1
(43) Pub. Date: Dec. 6, 2012

(54) STARTER WITH NOISE REDUCTION DEVICE

(75) Inventor: Yoichi SHOJI, Anjo-shi (JP)

(73) Assignee: DENSO CORPORATION, Kariya-city, (JP)

(21) Appl. No.: 13/482,403

(22) Filed: May 29, 2012

(30) Foreign Application Priority Data
May 31, 2011 (JP) 2011-121789

(51) Int. Cl. F02N 11/08

(52) U.S. Cl. 290/38 R

(57) ABSTRACT

A starter includes a motor, an electromagnetic switch, and a noise reduction device. The motor is connected to a power supply line via a motor lead line, and produces torque by power supplied from a battery. The electromagnetic switch includes an electric contact connected to the power supply line via a battery-side terminal and a motor-side terminal, and opens and closes the electric contact in conjunction with on-off operation of a solenoid. The noise reduction device includes at least one capacitor inserted between ground and the power supply line, and reduces noise produced from the motor. In the starter, a conductor is inserted between the motor-side terminal and the motor lead line as an inductance component capable of increasing an impedance of a starter equivalent circuit of the starter. The at least one capacitor is inserted between ground and one end of the conductor connected to the motor-side terminal.

### CROSS-REFERENCE TO RELATED APPLICATION

This application is based on and claims the benefit of priority from earlier Japanese Patent Application No. 2011-121789 filed May 31, 2011, the description of which is incorporated herein by reference.

### BACKGROUND OF THE INVENTION

1. Technical Field of the Invention

The present invention relates to a starter with a noise reduction device for reducing noise produced on rotation of a motor.

2. Related Art

Recently, in order to reduce carbon dioxide emitted by a vehicle and to improve fuel efficiency, there is an increase in a vehicle with a function to cut fuel supply to an engine to automatically stop an engine on stopping at a signal light at an intersection. This function is also called an “idling stop function”. By this function, the engine is stopped. After that, a start operation is carried out by a user. In response to the start operation, a starter is activated by instruction of an ECU (electronic control unit) to automatically restart the engine.

On the other hand, in a starter using a commutator motor, a spark may be generated between a commutator and a brush during rotation of the motor. The spark causes noise to be generated in devices such as radios, which gives a user a sense of discomfort.

With respect to such a problem, DE-A-102008001570 discloses a technique for suppressing noise generated from the motor by using a capacitor circuit with at least one capacitor connected in parallel with the motor.

A capacitor for a reduction of noise uses a property of being more likely to pass alternating current as its frequency is higher. However, the capacitor cannot pass alternating currents in the same manner. In a high-frequency domain equal to or higher than so-called self-resonant frequency, an effect of an inductance component (equivalent series inductance) of the capacitor becomes pronounced, and therefore, an impedance of the capacitor becomes larger.

Accordingly, in the capacitor circuit disclosed in DE-A-102008001570, noise reduction effect can be reduced in a high-frequency domain equal to or higher than a given frequency.

### SUMMARY

The present disclosure provides a starter with a noise reduction device which is able to improve an effect to reduce noise produced from a motor.

According to an aspect of the present disclosure, there is provided a starter, comprising: a motor that is connected to a power supply line via a motor lead line and produces torque by power supplied from a battery; an electromagnetic switch that includes an electric contact which is connected to the power supply line via a battery-side terminal and a motor-side terminal, and opens and closes the electric contact in conjunction with on-off operation of a solenoid; and a noise reduction device that includes at least one capacitor inserted between ground and the power supply line, and reduces noise produced from the motor, wherein: a conductor is inserted between the motor-side terminal and the motor lead line as an inductance component capable of increasing an impedance of a starter equivalent circuit of the starter; and the at least one capacitor being inserted between ground and one end of the conductor connected to the motor-side terminal.

Here, a noise reduction effect due to the noise reduction device is expressed as a ratio of an impedance of a starter equivalent circuit to an impedance of the noise reduction device. That is, as the impedance of the noise reduction device becomes smaller compared to the impedance of the starter equivalent circuit, the noise reduction effect becomes more effective.

In the starter of the present disclosure, the conductor to be an additional inductance component is inserted in the power supply line of the motor. Due to this, the impedance of the starter equivalent circuit becomes larger. As a result, compared to the impedance of the starter equivalent circuit, the impedance of the noise reduction device that includes at least one capacitor becomes relatively smaller. This results in an improvement in the noise reduction effect.

In the starter, the at least one capacitor may comprise a first capacitor that is inserted between the ground and one end of the conductor connected to the motor-side terminal, and a second capacitor that is inserted between the ground and the other end of the conductor connected to the motor lead line. One of the first capacitor and the second capacitor may have a first capacitance capable of reducing low-frequency noise. The other of the first capacitor and the second capacitor may have a second capacitance capable of reducing high-frequency noise.

In this configuration, one of the first capacitor and the second capacitor has a first capacitance capable of reducing low-frequency noise, and the other of the first capacitor and the second capacitor has a second capacitance capable of reducing low-frequency noise. This can obtain the noise reduction effect in a broader frequency domain.

Here, the low-frequency noise corresponds to noise that becomes a problem in a radio wave frequency band (e.g., 522 to 1602 MHz) used for, e.g., an AM broadcast. The high-frequency noise corresponds to noise that becomes a problem in a radio wave frequency band (e.g., 76 to 108 MHz) used for, e.g., FM broadcast. These frequency values for the AM and FM broadcasts are examples used in Japan, and then vary depending on countries and areas.

For example, it is preferable that the capacitor capable of reducing low-frequency noise has a capacitance of several tens of microfarads (μF), and the capacitor capable of reducing high-frequency noise has a capacitance of several nanofarads (nF).

In the starter, at least one of the first capacitor and the second capacitor may be connected in series with a resistor.

When the capacitors with the different capacitance are connected in parallel with each other, a parallel resonance circuit of an inductor and a capacitor is produced at an intermediate frequency between the respective self-resonant points, so that so-called anti-resonance is produced. In this case, an impedance of the noise reduction device is increased. As a result, the attenuation characteristic of the noise reduction device may be decreased.

According to the present disclosure, at least one of the first capacitor and the second capacitor may be connected in series with a resistor. This can reduce composite impedance on parallel resonance and then can reduce a decrease in the attenuation characteristic of the noise reduction device due to parallel resonance.

In the starter, the conductor may include a female screw formed on an inner circumference of one end which is cylindrically-shaped and a male screw formed on an outer circumference of the other end which is rod-like shaped. The female screw may be joined to the motor-side terminal. The male screw may be connected to the motor lead line.

According to the above configuration, the female screw is formed at one end of the conductor, and is joined to the motor-side terminal. Due to this, the conductor can be easily secured to the motor-side terminal. Further, the male screw is formed at the other end of the conductor. Due to this, the male screw of the conductor can be connected to the motor lead line, similar to a case where the motor lead line is connected to the motor-side terminal.

### BRIEF DESCRIPTION OF THE DRAWINGS

In the accompanying drawings:

FIG. 1 is a motor circuit diagram of a starter with a noise reduction device according to an embodiment of the present invention;

FIG. 2 is a plan view of the noise reduction device in FIG. 1; and

FIG. 3 is a side view of the starter in FIG. 1.

### DETAILED DESCRIPTION OF PREFERRED EMBODIMENTS

Referring to the accompanying drawings, a starter with a reduction device according to an exemplary embodiment of the present invention will now be described below.

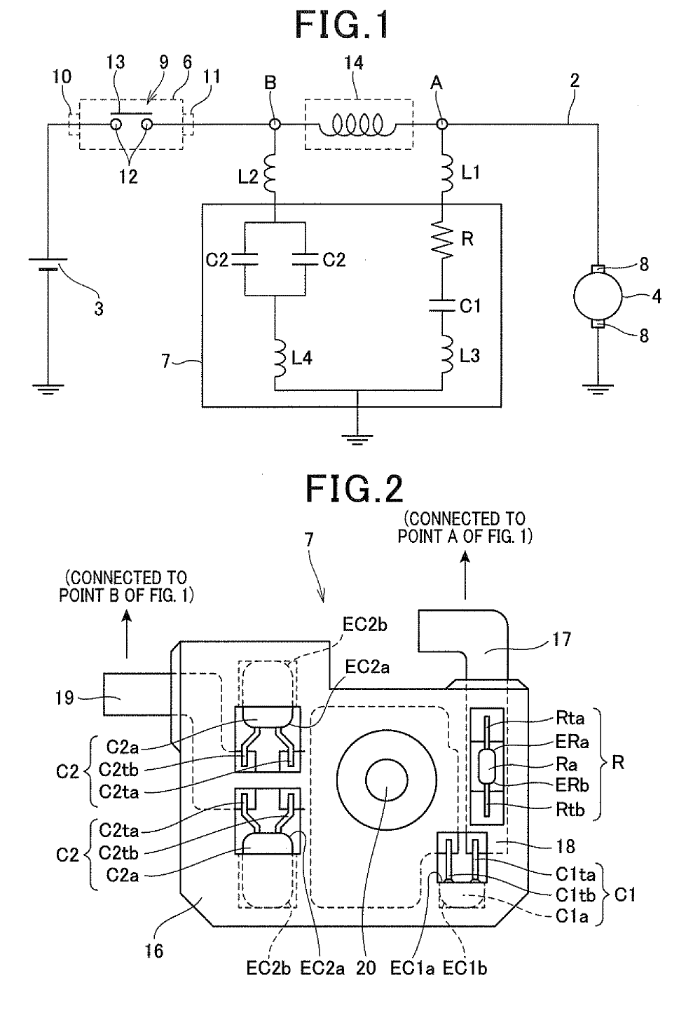

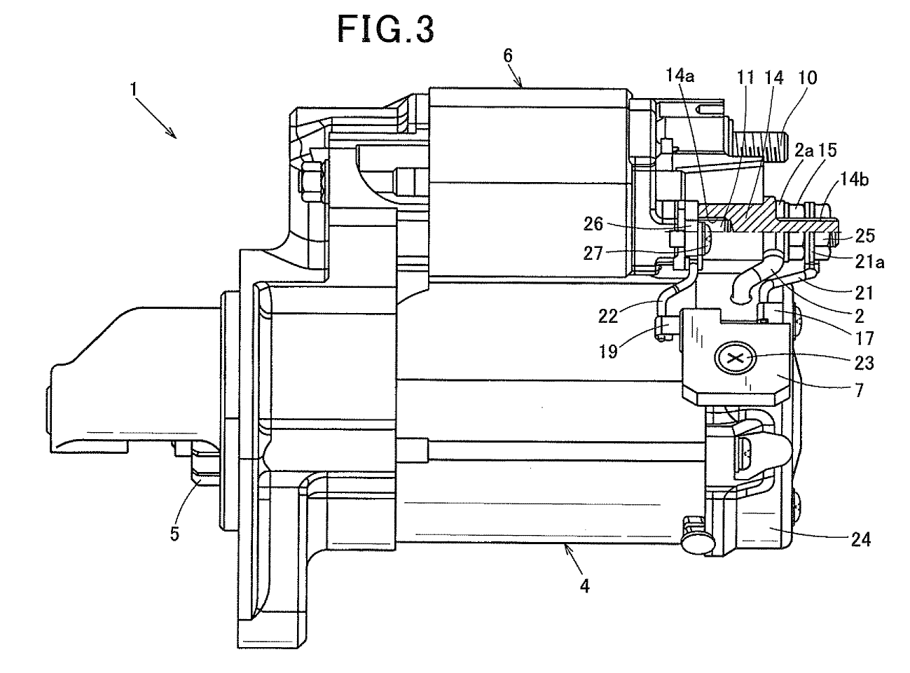

FIGS. 1 to 3 show an example of a starter using a noise reduction device (noise suppression device) according to the present embodiment. The starter of the present the embodiment can be applied to an on-vehicle engine system. As shown in FIG. 3, a starter 1 includes a motor 4, a pinion 5, an electromagnetic switch 6, and a noise reduction device 7. The motor 4 is connected to a power supply line 31 (see FIG. 1) via a motor lead line 2 and generates torque by receiving power supplied from a battery 3. The pinion 5 transmits torque from the motor 4 to a ring gear of an engine (not shown) mounted on a vehicle. The electromagnetic switch 6 connects and disconnects energization current to the motor 4. The noise reduction device 7 is able to reduce noise produced on rotation of the motor 4.

The motor 4 is a well-known commutator motor including a field, an armature, and a brush. The field is configured by a plurality of permanent magnets or field coils arranged on an inner circumference of a yoke forming a magnetic circuit. The armature is rotatably arranged on an inner circumference of the field and includes a commutator. The brush slides on an outer circumference of the commutator in conjunction with rotation of the armature.

The electromagnetic switch 6 includes a solenoid that forms an electromagnet by energization of an embedded coil and attracts a plunger by attractive force of the electromagnet. By on/off operation of the solenoid, i.e., excitation/non-excitation of the coil, the electromagnetic switch 6 opens and closes a main contact 9.

The main contact 9 is configured by a set of fixed contacts 12 and a moving contact 13 (see FIG. 1). The set of fixed contacts 12 are connected to the power supply line 31 via a battery side terminal bolt 10 and a motor side terminal bolt (hereinafter referred to as “M terminal bolt”) 11. The moving contact 13 electrically connects and disconnects between the set of fixed contacts 12 in response to movement of the plunger. The moving contact 13 contacts the set of fixed contacts 12 to allow current to flow across the set of fixed contacts 12, thereby closing the main contact 9. On the other hand, the moving contact 13 moves away from the set of fixed contacts 12, thereby opening the main contact 9.

As shown in FIG. 1, the starter 1 of the present embodiment is provided with a conductor 14 which is a conductor component or part additionally inserted in the power supply line 31 of the motor 4 as an inductance component. The conductor 14 is composed of, e.g., iron, and has two ends, i.e., a cylindrically-shaped end (one end) and a rod-like shaped end (the other end), where a female screw 14a is formed on an inner circumference of the cylindrically-shaped end, and a male screw 14b is formed on an outer circumference of the rod-like shaped end. As shown in FIG. 3, the conductor 14 is attached by combining the female screw 14a with the M terminal bolt 11, and the male screw 14b is connected to the motor lead line 2. The conductor 14 is inserted between the M terminal bolt 11 and the motor lead line 2.

A ring-like terminal 2a is located at one end portion of the motor lead line 2 that is connected to the male screw 14b of the conductor 14. The ring-like terminal 2a is fitted in an outer circumference of the male screw 14b. After that, the conductor 14 is fixed by joining and tightening a nut 15 to the male screw 14b. The other end portion, i.e., an anti-terminal side end portion of the motor lead line 2 is connected to a positive side brush inside the motor 4. A field winding may be used as the field of the motor 4. If the field winding is used, such a configuration that connects the motor lead line 2 to the field winding may be adopted.

Next, the noise reduction device 7 will be described below.

As shown in FIG. 1, the noise reduction device 7 includes a capacitor C1, a resistor R, and two capacitors C2. The capacitor C1 is inserted between the ground (earth) and the other end (point A in FIG. 1) of the conductor 14 that is connected to the motor lead line 2. The resistor R is connected in series with the capacitor C1. The two capacitors C2 is inserted in parallel between the ground and one end (point B in FIG. 1) of the conductor 14 that is connected to the M terminal bolt 11.

The capacitor C1 has a capacitance of e.g., 4.7 nF and is used for reducing high-frequency noise that becomes a problem in a radio wave frequency band mainly used for FM (frequency modulation) broadcast. Each of the two capacitors C2 has a capacitance of e.g., 10 μF and is used for reducing low-frequency noise that becomes a problem in a radio wave frequency band mainly used for AM (amplitude modulation) broadcast.

The resistor R is used for reducing a decrease in an attenuation characteristic of the noise reduction device 7 due to parallel resonance. That is, when capacitors with the difference capacitance are connected in parallel with each other, anti-resonance is produced at an intermediate frequency between the respective self-resonant points to decrease characteristics, and then, the attenuation characteristic of the noise reduction device may be decreased. Then, in order to reduce unnecessary parallel resonance in parallel resonance frequency, the resistor is connected in series with the capacitor C1.

A resistance value of the resistor R corresponds to a value which is obtained by subtracting a sum of a resistance of e.g., wiring and an ESR (equivalent series resistance) of the respective capacitors C1 and C2 from a resistance value required to reduce parallel resonance. Here, the resistance value required to reduce parallel resonance is calculated based on (i) a total inductance obtained by summing all inductance included in a parallel resonance circuit and a sum of an ESL (equivalent series inductance) of the respective capacitors C1 and C2 and (ii) a composite capacitance of the capacitors C1 and C2.

As shown in FIG. 2, the capacitor C1, the resistor R, and the two capacitors C2 are incorporated in a package 16 which is made of, for example, a resin package. The capacitor C1 and the two capacitors C2 are made of, for example, ceramic capacitors.

The capacitor C1 includes a capacitor body C1a and two lead terminals (hereinafter referred to as “first and second lead terminals C1ta and C1tb”). The capacitor body C1a has both ends EC1a and EC1b in a given direction (e.g., length or width direction). The first and second lead terminals C1ta and C1tb are extracted outward from the same end EC1a of the capacitor body C1a in the same direction with respect to the capacitor body C1a, as shown in FIG. 2.

The two capacitors C2 includes a capacitor body C2a and two lead terminals (hereinafter referred to as “first and second lead terminals C2ta and C2tb”). The capacitor body C2a has both ends EC2a and EC2b in a given direction (e.g., length or width direction). The first and second lead terminals C2ta and C2tb are extracted outward from the same end EC2a of the capacitor body C2a in the same direction with respect to the capacitor body C2a, as shown in FIG. 2.

The resistor R includes a resistor body Ra and two lead terminals (hereinafter referred to as “first and second lead terminals Rta and Rtb”). The resistor body Ra has both ends ERa and ERb in a given direction (e.g., length or width direction). The first and second lead terminals Rta and Rtb are extracted outward from the different ends ERa and ERb of the resistor body Ra in the opposite direction with respect to each other, as shown in FIG. 2.

In the package 16, a first positive electrode 17, an internal electrode 18, a second positive electrode 19, and a grounding electrode (earth electrode) 20 are inserted and fixed. The first positive electrode 17 is connected to one of the lead terminals Rta and Rtb of the resistor R. The internal electrode 18 is connected to the other of the lead terminals Rta and Rtb of the resistor R and one of the lead terminals C1ta and C1tb of the capacitor C1. The second positive electrode 19 is connected to the other of the lead terminals C1ta and C1tb of the capacitor C1 and one of the lead terminals C2ta and C2tb of the capacitors C2. The grounding electrode 20 is connected to the other of the lead terminals C2ta and C2tb of the capacitors C2.

In the capacitors C1, C2 and the resistor R, these respective lead terminals C1ta, C1tb, C2ta, C2tb, Rta, and Rtb are joined to the corresponding electrodes 17 to 20 by welding or soldering.

After the lead terminals C1ta, C1tb, C2ta, C2tb, Rta, and Rtb are connected to the corresponding electrodes 17 to 20, a surface of the package 16 where the capacitors C1, C2 and the resistor R are incorporated is sealed by a cover.

The first positive electrode 17 is connected to point A in FIG. 1 via a branch wire 21, as shown in FIG. 3. The second positive electrode 19 is connected to point 13 via a branch wire 22, as shown in FIG. 3. The grounding electrode 20 is fixed to an end frame 24 which covers a rear end of the motor 4 by a screw 23, as shown in FIG. 3.

As shown in FIG. 3, an anti-electrode side end of the branch wire 21 is provided with a ring-like terminal 21a where the male screw 14b of the conductor 14 is fitted. The anti-electrode side end of the branch wire 21 is fixed by a tightening force of a nut 25 coupled to the male screw 14b.

An anti-electrode side end of the branch wire 22 is fixed to a connecting plate 26 coupled to the M terminal bolt 11, by a screw 27, as shown in FIG. 3.

In FIG. 1, L1 denotes an inductance component included in the branch wire 21, L2 denotes an inductance component included in the branch wire 22, and L3 and L4 represent an inductance component included in the respective electrodes 18, 19 and 20 of the noise reduction device 7.

According to the noise reduction device 7 of the present embodiment, the conductor 14 to be an additional inductance component is inserted between the M terminal bolt 11 and the motor lead line 2. The noise reduction device 7 is connected between the ground and both ends (points A and B in FIG. 1) of the conductor 14.

A noise reduction effect due to the noise reduction device 7 is expressed as a ratio of an impedance of a starter equivalent circuit to an impedance of the noise reduction device 7. That is, as the impedance of the noise reduction device 7 becomes smaller compared to the impedance of the starter equivalent circuit, the noise reduction effect becomes more effective.

In the starter 1 of the present embodiment, the conductor 14 to be an additional inductance component is inserted between the M terminal bolt 11 and the motor lead line 2. Due to this, the impedance of the starter equivalent circuit becomes larger. As a result, compared to the impedance of the starter equivalent circuit, the impedance of the noise reduction device 7 becomes relatively smaller. This can improve the noise reduction effect.

The conductor 14 has the female screw 14a at one end side thereof. The female screw 14a is joined to the M terminal bolt 11. Due to this, the conductor 14 can be easily secured to the M terminal bolt 11.

The conductor 14 has the male screw 14b at the other end side thereof. The motor lead line 2 is connected to the M terminal bolt 11. Similar to this case, the male screw 14b of the conductor 14 is fitted in the ring-like terminal 2a of the motor lead line 2 and then the nut 15 is tightened. Due to this, the conductor 14 can be easily connected to the motor lead line 2.

The starter 1 may be mounted in an engine room. In this case, there is a relatively enough space in an area around the M terminal bolt 11. Due to this, even if the conductor 14 is secured to the M terminal bolt 11, the starter 1 does not interfere with auxiliary component parts, an air supply pipe and an exhaust pipe, a cable, and so on located in an area around the engine, thereby having an advantage to mount the starter.

In the noise reduction device 7, the capacitor C1 with small capacitance (e.g., 4.7 nF) capable of reducing high-frequency noise is inserted between the ground and the other end of the conductor 14 connected to the motor lead line 2 (point A in FIG. 1). Further, the two capacitors C2 with large capacitance (e.g., 10 μF) capable of reducing low-frequency noise are inserted in parallel with each other between the ground and one end of the conductor 14 connected to the M terminal bolt 11 (point B in FIG. 1). This configuration of the capacitors C1, C2 can obtain the noise reduction effect in a broader frequency domain.

Here, the low-frequency noise corresponds to noise that becomes a problem in a radio wave frequency band used for, e.g., an AM broadcast. The high-frequency noise corresponds to noise that becomes a problem in a radio wave frequency band used for, e.g., FM broadcast.

In the noise reduction device 7, the resistor R is connected in series with the capacitor C1. This configuration of the resistor R can reduce the composite impedance on parallel resonance, thereby being able to reduce a decrease in the attenuation characteristic of the noise reduction device 7 due to parallel resonance.

### MODIFICATIONS

In the noise reduction device 7 of the above embodiment, the capacitor C1 is connected between the ground and the other end of the conductor 14 connected to the motor lead line 2, and the two capacitors C2 are connected between the ground and one end of the conductor 14 connected to the M terminal bolt 11.

The noise reduction device 7 may be configured by inserting any one of the capacitor C1 and the capacitors C2 between the ground and one end (point B in FIG. 1) of the conductor 14 connected to the M terminal bolt 11.

In the above embodiment, the resistor R is connected in series with the capacitor C1. The resistor R may be connected in series with the two capacitors C2.

In the above embodiment, a capacitance of the capacitor C1 is 4.7 nF, and a capacitance of the respective capacitors C2 is 10 μF. A value of the respective capacitances is an example and then may be arbitrarily set.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A starter, comprising:
a motor that is connected to a power supply line via a motor lead line and produces torque by power supplied from a battery;
an electromagnetic switch that includes an electric contact which is connected to the power supply line via a battery-side terminal and a motor-side terminal and opens and closes the electric contact in conjunction with on-off operation of a solenoid; and
a noise reduction device that includes at least one capacitor inserted between ground and the power supply line and reduces noise produced from the motor,
wherein:
a conductor is inserted between the motor-side terminal and the motor lead line as an inductance component capable of increasing an impedance of a starter equivalent circuit of the starter; and
the at least one capacitor is inserted between ground and one end of the conductor connected to the motor-side terminal.

2. The starter according to claim 1, wherein
the at least one capacitor comprises:
a first capacitor that is inserted between the ground and one end of the conductor connected to the motor-side terminal; and
a second capacitor that is inserted between the ground and the other end of the conductor connected to the motor lead line,
wherein:
one of the first capacitor and the second capacitor has a first capacitance capable of reducing low-frequency noise; and
the other of the first capacitor and the second capacitor has a second capacitance capable of reducing high-frequency noise.

3. The starter according to claim 2, wherein:
at least one of the first capacitor and the second capacitor is connected in series with a resistor.

4. The starter according to claim 1, wherein:
the conductor includes a female screw formed on an inner circumference of one end which is cylindrically-shaped and a male screw formed on an outer circumference of the other end which is rod-like shaped;
the female screw is joined to the motor-side terminal; and
the male screw is connected to the motor lead line.

5. The starter according to claim 2, wherein
the noise reduction device further includes:
a positive electrode that is connected to the power supply line via a branch wire;
a grounding electrode that is connected to ground via a motor body of the motor; and
a package into which the positive electrode and the grounding electrode are inserted and fixed, the package holding the first capacitor and the second capacitor.

6. A noise reduction device for a starter,
the starter including:
a motor that is connected to a power supply line via a motor lead line and produces torque by power supplied from a battery; and
an electromagnetic switch that includes an electric contact which is connected to the power supply line via a battery-side terminal and a motor-side terminal and opens and closes the electric contact in conjunction with on-off operation of a solenoid,
the noise reduction device comprising
at least one capacitor that reduces noise produced from the motor and is inserted between ground and one end of a conductor which is inserted between the motor-side terminal and the motor lead line as an inductance component capable of increasing an impedance of a starter equivalent circuit of the starter.

7. The noise reduction device according to claim 6, wherein:
the at least one capacitor comprises:
a first capacitor that is inserted between the ground and one end of the conductor connected to the motor-side terminal; and
a second capacitor that is inserted between the ground and the other end of the conductor connected to the motor lead line,
wherein:
one of the first capacitor and the second capacitor has a first capacitance capable of reducing low-frequency noise; and
the other of the first capacitor and the second capacitor has a second capacitance capable of reducing high-frequency noise.

8. The noise reduction device according to claim 7, wherein:
at least one of the first capacitor and the second capacitor is connected in series with a resistor.

9. The noise reduction device according to claim 6, wherein:
the conductor includes a female screw formed on an inner circumference of one end which is cylindrically-shaped and a male screw formed on an outer circumference of the other end which is rod-like shaped;
the female screw is joined to the motor-side terminal; and
the male screw is connected to the motor lead line.

10. The noise reduction device according to claim 7, further comprising:
a positive electrode that is connected to the power supply line via a branch wire;
a grounding electrode that is connected to ground via a motor body of the motor; and
a package into which the positive electrode and the grounding electrode are inserted and fixed, the package holding the first capacitor and the second capacitor.
